(19) United States
(12) Patent Application Publication
(10) Pub. No.: US 2008/0151073 A1
(43) Pub. Date: Jun. 26, 2008

(54) Apparatus, Method and Program for Information Processing

(75) Inventor: Masayuki Ryuto, Kanagawa (JP)

Correspondence Address: BIRCH STEWART KOLASCH & BIRCH, PO BOX 747, FALLS CHURCH, VA, 22040-0747, US

(73) Assignee: FUJIFILM Corporation, Tokyo (JP)

(21) Appl. No.: 11/793,715

(22) PCT Filed: Dec. 22, 2005
(86) PCT No.: PCT/JP2005/024193

§ 371 Date: Jul. 30, 2007

(30) Foreign Application Priority Data
Dec. 24, 2004 (JP) 2004-373945

(51) Int. Cl. H04N 5/76

(52) U.S. Cl. 348/231.6; 348/E05.031

(57) ABSTRACT

A personal computer (12) executes an information processing program (43) to start a shooting process. Under the shooting process, a judgment circuit (48) reads an allowable range of each shooting parameter from a HDD (42) and judges whether all the shooting parameters sent from a digital camera (10) via a communication I/F (47) are within the allowable range. A monitor (13) displays shooting parameter information (64) sent from the digital camera (10) on a picture window (60). The shooting parameters that are judged to be outside of the allowable range by the judgment circuit (48) are displayed distinguishably.

### TECHNICAL FIELD

The present invention relates to an information processing apparatus, an information processing method and an information processing program for an image capture system, which is utilized in a photographic studio specializing in memorial shots and commercial shots.

### BACKGROUND ART

Recently, an image capture system, which can receive a print order of images immediately after shooting, has been brought into photo studios specializing in memorial shots and commercial shots. Such image capture system has an information processing apparatus, like a personal computer, for processing the images captured by a digital camera, and a monitor for displaying the captured images and print order information of these images (see Japanese Laid-open Patent Application No. 2002-139805).

In the image capture system disclosed in the Japanese Laid-open Patent Application No. 2002-139805, correction conditions for color, hue, saturation, sharpness and the like, are predetermined for each camera, and desired pictures are obtained efficiently by processing the images in accordance with these correction conditions. In the above-mentioned image capture system, the captured image is displayed on the monitor of the personal computer to be viewed by a customer. By reviewing the image displayed on the monitor, the customer considers whether to try another shooting.

In studio shooting, shooting parameters such as shutter speed, f-number, white balance and the like are needed to be changed in accordance with a shooting scene. In many photo studios, however, part-timers who are not familiar with the digital camera perform shooting instead of expert cameramen in order to save on personal costs. As a result, there is a possibility that the shooting parameters deviate from an allowable range of an appropriate shooting parameters during the shooting because of the part-timers not knowing how to set up the shooting parameters or to change values appropriately.

The system described in the Japanese Laid-open Patent Application No. 2002-139805 merely displays the captured image on the monitor. For this configuration, it is impossible to know whether the shooting parameters are set appropriate or not.

In view of the foregoing, an object of the present invention is to provide an information processing apparatus, an information processing method and an information processing program that make it easy for an operator who is not familiar with the operation of the digital camera to confirm whether the shooting is conducted with appropriate shooting parameters or not.

### DISCLOSURE OF INVENTION

In order to achieve the above and other objects, an information processing apparatus of the present invention includes a parameter acquisition device, a memory, a judgment device and an indicator. The parameter acquisition device acquires shooting parameters set in a digital camera. The memory stores an allowable range for each shooting parameter. The judgment device reads the allowable range from the memory and judges whether each shooting parameter acquired by the parameter acquisition device is within the allowable range. The indicator indicates the shooting parameters which are judged to be outside of the allowable range.

At least one of the shooting parameters is shutter speed, f-number, zoom magnification, ISO sensitivity or white balance. The allowable range is set to obtain finished prints in good condition. The allowable range is set in accordance with a shooting scene.

In a preferred embodiment of the present invention, the indicator displays the shooting parameters judged to be outside of the allowable range by the judgment device on the monitor differently from other shooting parameters judged to be within the allowable range.

An information processing method of the present invention includes the steps of acquiring, reading, judging and indicating. The acquiring step acquires shooting parameters set in a digital camera. The reading step reads an allowable range for each shooting parameter from a memory. The judging step judges whether each shooting parameter is within the allowable range. The indicating step indicates the shooting parameters which are judged to be outside of the allowable range.

An information processing program of the present invention enables a personal computer to perform the steps of acquiring, reading, judging and indicating. The acquiring step acquires shooting parameters set in a digital camera. The reading step reads an allowable range for each shooting parameter from a memory. The judging step judges whether each shooting parameter is within the allowable range. The indicating step indicates the shooting parameters which are judged to be outside of the allowable range.

According to the information processing apparatus, method and program of the present invention, the indicator indicates the shooting parameters which are judged to be outside of the allowable range, which allows to obtain the finished prints in good condition. Owing to this, it is possible for an operator who is not familiar with the operation of the digital camera to confirm whether the shooting condition is appropriate or not.

### BRIEF DESCRIPTION OF DRAWINGS

FIG. 1 is a schematic diagram showing a structure of an image capture system including a personal computer to which the present invention is applied;

FIG. 2 is a block diagram showing a structure of a digital camera;

FIG. 3 is a block diagram showing a structure of the personal computer;

FIG. 4 is an explanatory view showing a customer management window displayed on a monitor of the personal computer;

FIG. 5 is an explanatory view showing a picture window displayed on the monitor of the personal computer;

FIG. 6 is an enlarged view showing shooting parameter information in the picture window; and

FIG. 7 is a flow chart showing a procedure of an information processing of the present invention.

### BEST MODE FOR CARRYING OUT THE INVENTION

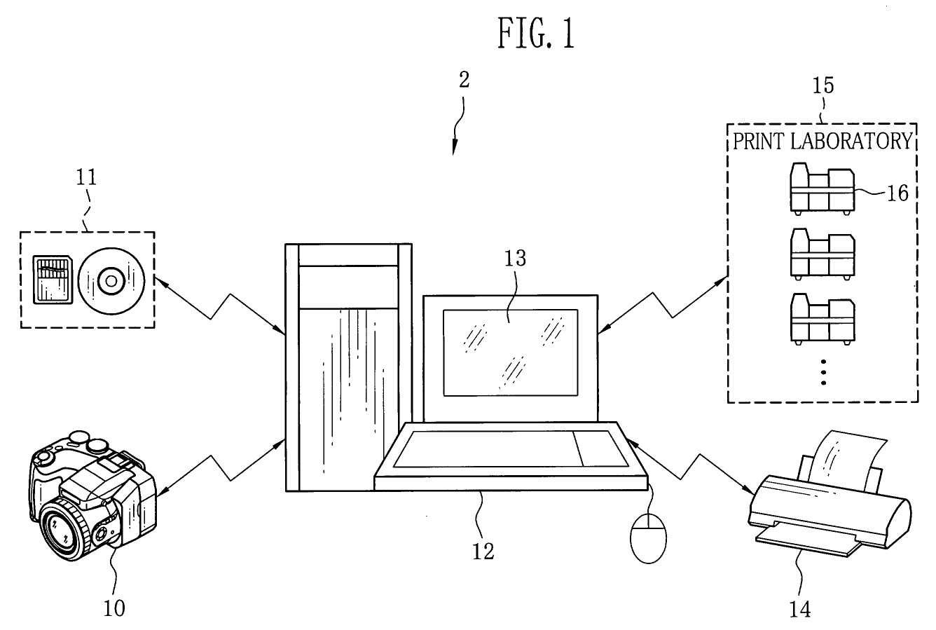

In FIG. 1, an image capture system 2 is provided in photo studios specializing in memorial shots like wedding shots, and commercial shots. The image capture system 2 imports image data obtained with a digital camera 10, or image data recorded in a recording medium 11, such as a memory card or CD-R, into a personal computer (hereinafter, abbreviated as PC) 12 and displays images on a monitor 13 of the PC 12 to receive a print order of the images. The image data recorded in the recording medium 11 includes images on photo films digitized into TIFF or JPEG format. The image capture system 2 then produces prints according to the print order, by a printer 14 equipped in the photo studio or by laboratory printers 16 equipped in a laboratory 15.

The digital camera 10, the printer 14 and the laboratory printers 16 are connected to the PC 12 through, for instance, a communication cable compliant with IEEE 1394 or USB (Universal Serial Bus), a wireless LAN or the like, and communicate data with the PC 12 mutually. The recording medium 11 exchanges data with the PC 12 through a specific driver.

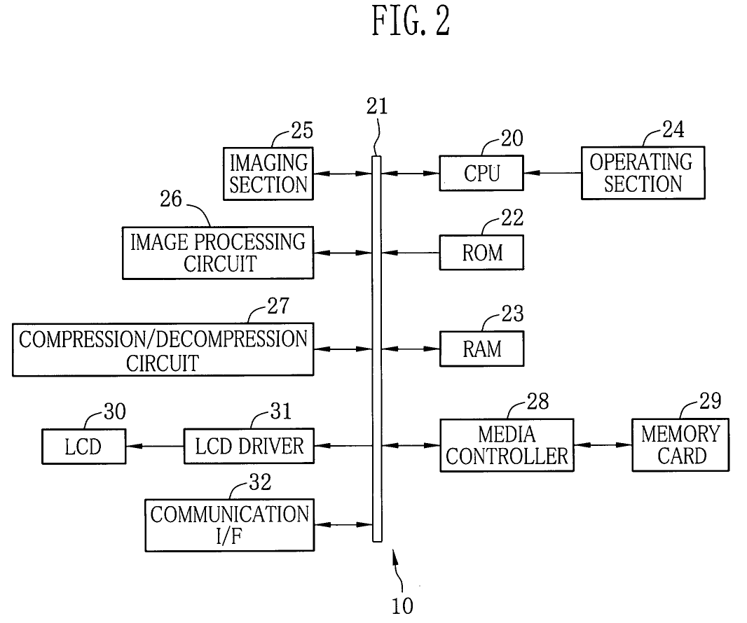

In FIG. 2, a CPU 20 is connected to all components of the digital camera 10 through a data bus 21, and comprehensively controls operations of the digital camera 10. A ROM 22 stores various programs and data necessary for the operation of the digital camera 10. The CPU 20 reads the programs and data from the ROM 22 to execute various processing. The CPU 20 operates every component of the digital camera 10 in accordance with operations of an operating section 24. The operating section 24 is constituted of a shutter release button and set-up buttons to set up shooting parameters, such as f-number, shutter speed, zoom magnification, ISO sensitivity, white balance and the like.

An imaging section 25 is provided with a well-known taking lens, CCD and A/D converter. The imaging section 25 performs photoelectric conversion of an optical image of a subject formed by the taking lens by use of the CCD. An image signal is then converted into image data and is outputted. The image data outputted from the imaging section 25 is temporarily stored in a RAM 23. The image data is raw image data (CCD RAW data) before going through image processing like white-balance correction and the like. One pixel is constituted of RGB data, and each color data is represented by 12 bits.

An image processing circuit 26 reads the raw image data from the RAM 23 to convert the 12-bit pixel data of each color into 8-bit pixel data, and applies thereto the white-balance correction, y correction and YC conversion to output original image data. The image processing circuit 26 thins out pixels of the original image data to produce reduced image data (hereinafter, referred to as thumbnail image data) of, for instance, 1280×960 pixels.

A compression/decompression circuit 27 compresses the image data of the original image and the thumbnail image according to JPEG format. The image data compressed by the compression/decompression circuit 27 is once written into the RAM 23, and then is recorded in a memory card 29 by a media controller 28.

Under the control of a LCD driver 31, an LCD 30 displays through images of subjects continuously during the shooting, or reproduces the images which are read from the memory card 29 and displays the reproduced images. A communication interface (I/F) 32 sends the raw image data outputted from the imaging section 25, the image data of the original image and the thumbnail image compressed by the compression/decompression circuit 27 (hereinafter, referred to as compressed image data) and the shooting parameters set on an operating section 24 to the PC 12 via the above mentioned communication cable or the wireless LAN.

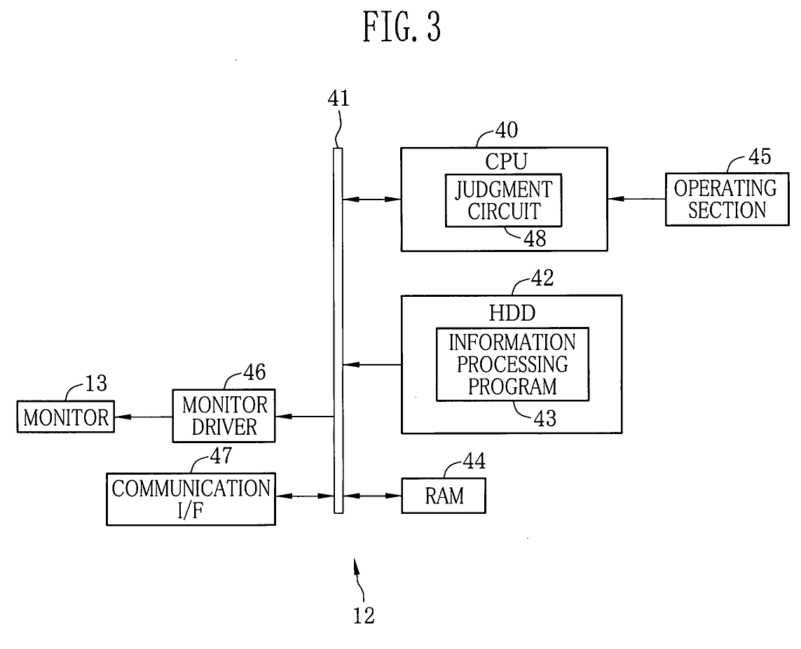

In FIG. 3, a CPU 40 is connected to all components of the PC 12 through a data bus 41, and comprehensively controls operations of the PC 12. A hard disk drive (HDD) 42 stores an information processing program (hereinafter, referred merely to as program) 43 as well as various programs and data necessary for the operation of the PC 12. The data stored in the HDD 42 includes the image data sent from the digital camera 10, customer management data which contains customers' personal information, print order information and so on, and is stored in connection with the image data and data representing an allowable range of each shooting parameter of the digital camera 10 (the range required to obtain a good print of quality recommended by the photo studio where the image capture system 2 is provided).

The program 43 allows the PC 12 to execute all processes of shooting with the digital camera 10, importing image data from the recording medium 11, presenting images to a customer for selection of the images to be printed, performing color correction, gradation correction or the like onto the image data, receiving the print order, sending it to the laboratory and producing an index print to check produced prints. The program 43 is recorded in the recording medium 11, such as CD-ROM, DVD-ROM, or the like, and is previously installed in the HDD 42 from the recording medium 11.

The CPU 40 loads the programs and data from the HDD 42 into a RAM 44, which is a work memory, to execute various processing. The CPU 40 operates every component of the PC 12 in accordance with directions inputted from an operating section 45 constituted of a keyboard and a mouse.

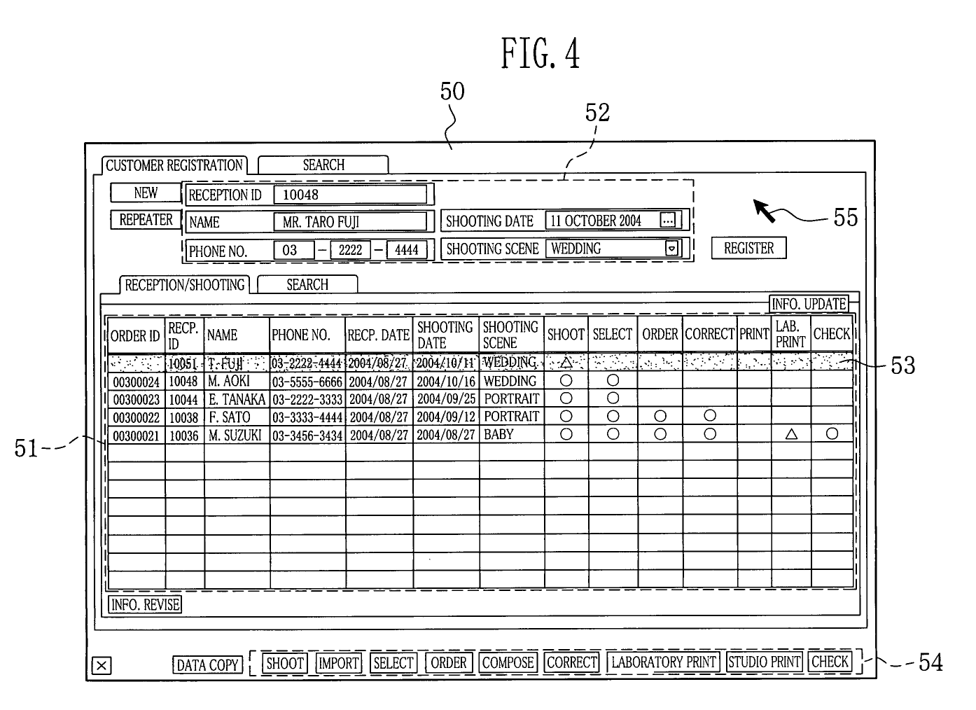

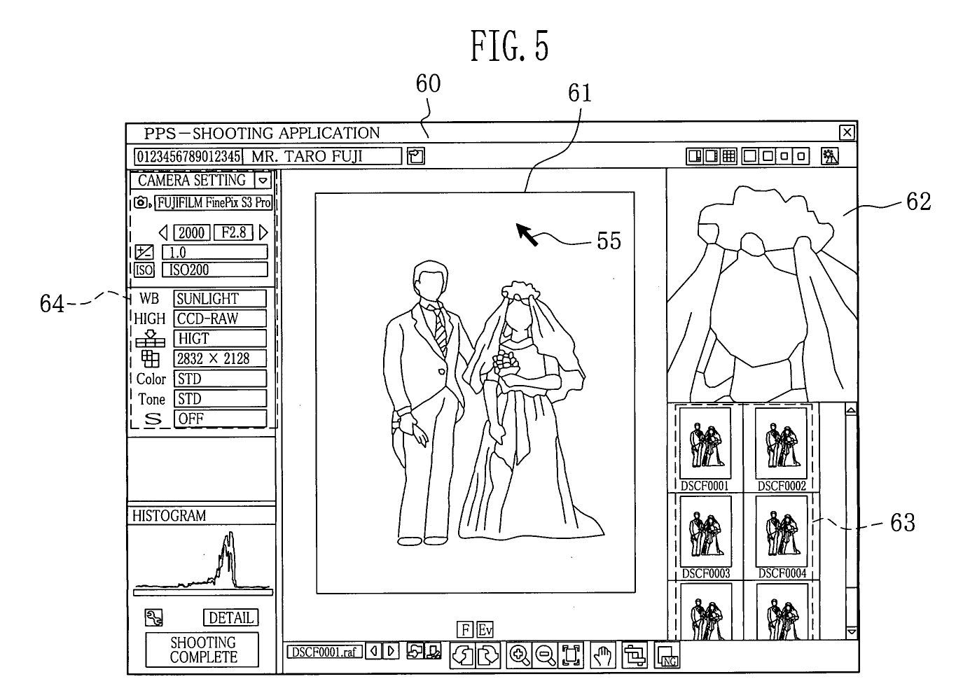

The monitor 13 displays a customer management window 50 (see FIG. 4) or a picture window 60 (see FIG. 5) under the control of a monitor driver 46. These windows 50 and 60 are described later in detail. A communication I/F 47 receives the image data from the digital camera 10 or the recording medium 11, and transmits a command for printing to the printer 14 or the laboratory printers 16.

When the program 43 is started up in accordance with the operation of the operating section 45, the monitor 13 displays the customer management window 50, as shown in FIG. 4. On the customer management window 50, registration of new customers, correction or deletion of the registered information, search of the registered customers are performed in accordance with the operational directions inputted from the operating section 45. The customer management window 50 has a list 51 displays a shooting date, a shooting scene (wedding, baby, etc.), progress of each process as well as personal information of customers (order ID, reception ID, name and phone number) of the image capture system 2. In the upper area of the customer management window 50, information 52 of the selected customer is shown. The selected customer is shown distinct from the other customers by a cursor 53 (shown by hatching) on the list 51.

In the lower area of the customer management window 50, buttons 54 (“SHOOT”, “IMPORT”, “SELECT”, “ORDER”, “COMPOSE”, “CORRECT”, “LABORATORY PRINT”, “STUDIO PRINT” and “CHECK” buttons) are provided. Placing a pointer 55 onto one of these buttons and clicking the mouse will lead to shift to the corresponding process and the window switches for the corresponding process.

When the “SHOOT” button is selected, a shooting process starts for assisting the shooting by the digital camera 10. As shown in FIG. 3, a judgment circuit 48 of the CPU 40 is activated upon starting the shooting process. The judgment circuit 48 reads the allowable range of each shooting parameter from the HDD 42 and judges whether all the shooting parameters sent from the digital camera 10 via the communication I/F 47 are within the allowable range.

Additionally, during the shooting process, the monitor 13 displays the picture window 60, as shown in FIG. 5. The picture window 60 displays a whole view 61 of the original image read from the HDD 42, a partial view 62 including a face image of the thumbnail image, a list 63 of the thumbnail images and information of the shooting parameters (hereinafter, referred to as shooting parameter information) 64 sent from the digital camera 10.

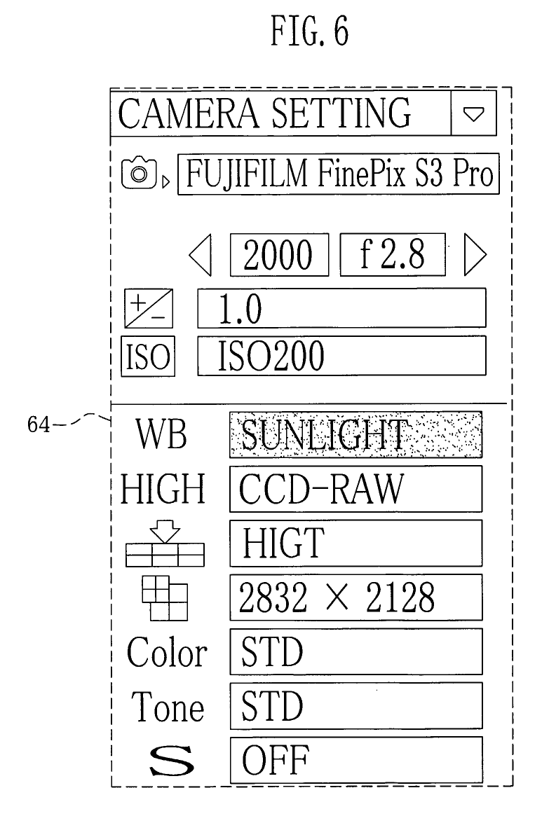

As shown in FIG. 6, a shooting parameter which is judged to be outside of the allowable range by the judgment circuit 48 (i.e. the white balance, or WB, in this embodiment) will change its color, or blink, or enlarge on the screen, appearing different from the shooting parameters which are judged to be within the allowable range (shown by hatching). When other shooting parameters than white balance are judged to be outside of the allowable range, each of the corresponding section on the shooting parameter information 64 is displayed differently. For instance, when shutter speed is outside of the range, the corresponding section “2000” on the shooting parameter information 64 is displayed differently. Likewise, for f/number, “f2.8” is displayed differently, and for ISO sensitivity, “ISO200” is displayed differently. When two or more shooting parameters are judged to be outside of the allowable range, the corresponding sections of all shooting parameters outside of the range are displayed differently in the same manner.

Referring back to FIG. 4, when the “IMPORT” button is selected, an importing process starts. Under the importing process, the image data is imported from the recording medium 11 and is stored in the HDD 42. When the “SELECT” button is selected, a selecting process starts. Under the selecting process, the images are displayed on the monitor 13 as preview images, and the images to be printed are selected by the customer.

When the “ORDER” button is selected, an ordering process starts. Under the ordering process, print size and print number of the images selected under the selecting process are entered. When the “COMPOSE” button is selected, a composing process starts. Under the composing process, each of the selected images is arranged in a predetermined layout frame and an original photo album is produced. When the “CORRECT” button is selected, a correcting process starts. Under the correcting process, color correction, gradation correction or the like is performed on the image data so that the finished prints have the quality recommended by the photo studio provided with the image capture system 2.

When the “LABORATORY PRINT” button is selected, a laboratory printing process starts. Under the laboratory printing process, an order to print the images selected under the selecting process in the size and number set under the ordering process is placed to the laboratory printers 16 of the laboratory 15. When the “STUDIO PRINT” button is selected, a studio printing process starts. Under the studio printing process, the print order is placed to the printer 14. When the “CHECK” button is selected, a checking process starts. Under the checking process, an index print is produced for checking prints when the prints produced by the laboratory printers 16 of the laboratory 15 are delivered.

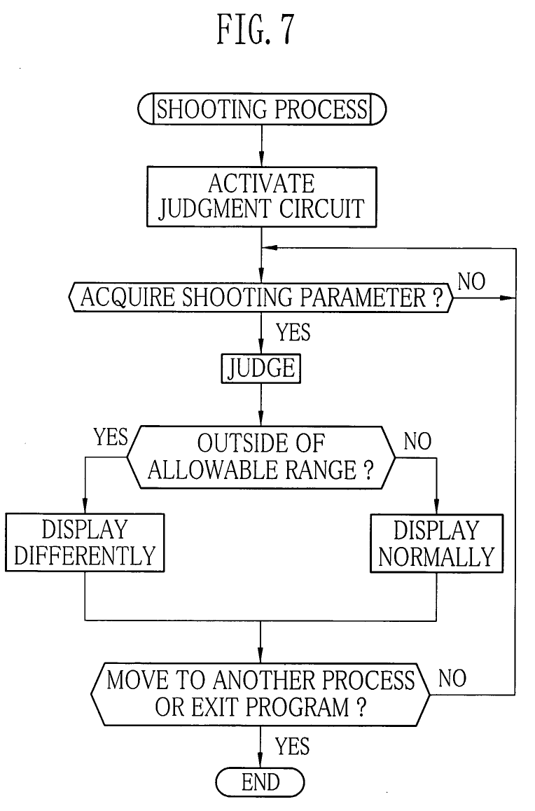

Next, a procedure of the information processing by the PC 12 is explained with referring to the flow chart shown in FIG. 7. Firstly, the operating section 45 is operated for starting up the program 43 to display the customer management window 50 on the monitor 13. On the customer management window 50, the registration of new customers, correction or deletion of the registered information, search of the registered customers are performed.

When the “SHOOT” button is selected to start the shooting process, the judgment circuit 48 of the CPU 40 is activated. When the shooting is performed with the digital camera 10, the raw image data, the compressed image data of the original image and the thumbnail image are produced and recorded in the memory card 29. These data recorded in the memory card 29 is inputted from the communication I/F 47 to be recorded in the HDD 42. Also, the shooting parameters of the digital camera 10 are sent to the HDD 42 at all times.

The judgment circuit 48 reads the allowable range of each shooting parameter from the HDD 42 and judges whether all the shooting parameters sent from the digital camera 10 are within the allowable range. The shooting parameters which are judged to be outside of the allowable range by the judgment circuit 48 are displayed differently from the shooting parameters which are judged to be within the allowable range on the shooting parameter information 64 of the picture window 60. When any of the shooting parameters are displayed differently from others, a cameraman of the digital camera 10 confirms which parameters are displayed differently on the monitor 13. Then the cameraman operates the operating section 24 of the digital camera 10 to change these shooting parameters such that they fall within the allowable range The information processing procedure is repeated until the executed process shifts from the shooting process to another or until the program 43 is completed.

When the shooting with the digital camera 10 is completed, each process is selected to be executed. Then, the prints according to the print order from the customer are produced by the printer 14 or by the laboratory printers 16. The produced prints are handed to the customer after the payment is made.

In the PC 12, the shooting parameters set in the digital camera 10 are acquired through the communication I/F, and the acquired shooting parameters are judged by the judgment circuit 48 whether they are within the allowable range stored in the HDD 42. The shooting parameters which are judged to be outside of the allowable range by the judgment section 48 are displayed on the monitor 13 differently from the shooting parameters which are judged to be within the allowable range. Owing to this, the cameraman can immediately change the parameters outside of the range to proper values.

It is preferable that the allowable range of the shooting parameters is set by those who have knowledge about the picture shooting, for instance, a photo studio manager or a service man of a dealer who helps an initial setup of the image capture system. It is also preferable to establish more than one allowable range for each shooting parameter so that the allowable range can be selected depending on the shooting scene, such as wedding, portrait and the like. For this configuration, the shooting parameter can be set appropriate for any shooting scene.

In the above embodiment, the shooting parameters are sent from the digital camera 10 to the PC 12 at all times. It is alternatively possible that the shooting parameters are sent to the PC 12 only when the change of the shooting parameters by the operating section 24 is detected by a sensor or the like.

Note that the monitor 13 may be constituted of a touch panel for convenient operation. For this configuration, the customer can perform various selecting operations by touching the screen of the monitor 13.

In the above embodiment, the shooting parameters which are judged to be outside of the allowable range by the judgment section 48 are indicated by displaying them on the shooting parameter information 64 differently from the shooting parameters which are within the allowable range. However, the present invention is not limited to this. For instance, a pop-up window for showing the shooting parameters outside of the range may be displayed on the monitor. Besides the display on the monitor, a beep tone, an announcement, vibration or the like may become the indication.

### INDUSTRIAL APPLICABILITY

The information processing apparatus, information processing method and information processing program of the present invention is suitable for an image capture system, which is utilized in photo studios specializing in memorial shots and commercial shots.

1. An information processing apparatus for receiving a print order of an image displayed on a monitor, said image being captured by a digital camera and being stored in a memory as image data, said information processing apparatus comprising:
a parameter acquisition device for acquiring shooting parameters set in said digital camera;
a memory for storing an allowable range for each of said shooting parameters to obtain an appropriate print;
a judgment device for judging whether each of said shooting parameters acquired by said parameter acquisition device is within said allowable range stored in said memory; and
an indicator for indicating said shooting parameters which are judged to be outside of said allowable range.

2. An information processing apparatus described in claim 1, wherein said indicator displays said shooting parameters judged to be outside of said allowable range by said judgment device on said monitor differently from other said shooting parameters judged to be within said allowable range.

3. An information processing apparatus described in claim 1, wherein said shooting parameters include at least one of shutter speed, f-number, zoom magnification, ISO sensitivity and white balance.

4. An information processing apparatus described in claim 1, wherein said allowable range is set in accordance with a shooting scene.

5. An information processing method for receiving a print order of an image displayed on a monitor, said image being captured by a digital camera and being stored in a memory as image data, said information processing method comprising the steps of:
acquiring shooting parameters set in said digital camera;
reading an allowable range for each of said shooting parameters from said memory;
judging whether each of said shooting parameters is within said allowable range; and
indicating said shooting parameters which are judged to be outside of said allowable range.

6. An information processing method described in claim 5, wherein said indicating step displays said shooting parameters judged to be outside of said allowable range by said judging step on said monitor differently from other said shooting parameters judged to be within said allowable range.

7. An information processing method described in claim 5, wherein said shooting parameters include at least one of shutter speed, f-number, zoom magnification, ISO sensitivity and white balance.

8. An information processing method described in claim 5, wherein said allowable range is set in accordance with a shooting scene.

9. An information processing program for enabling a personal computer to receive a print order of an image displayed on a monitor, said image being captured by a digital camera and being stored in a memory as image data, said information processing program comprising the steps of:
acquiring shooting parameters set in said digital camera;
reading an allowable range for each of said shooting parameters from said memory;
judging whether each of said shooting parameters is within said allowable range; and
indicating said shooting parameters which are judged to be outside of said allowable range.

10. An information processing program described in claim 9, wherein said indicating step displays said shooting parameters judged to be outside of said allowable range by said judging step on said monitor differently from other said shooting parameters judged to be within said allowable range.

11. An information processing program described in claim 9, wherein said shooting parameters include at least one of shutter speed, f-number, zoom magnification, ISO sensitivity and white balance.

12. An information processing program described in claim 9, wherein said allowable range is set in accordance with a shooting scene.
